(19) United States
(12) Patent Application Publication
(10) Pub. No.: US 2017/0038907 A1
(43) Pub. Date: Feb. 9, 2017

(54) INPUT DEVICE AND METHOD FOR CAPACITIVE TOUCH SCREEN

(71) Applicant: International Business Machines Corporation, Armonk, NY (US)

(72) Inventors: Roger A. Buckett, Winchester (GB); Jeremy Kelway, Bishopstoke (GB); Michael G. Taylor, Fareham (GB)

(21) Appl. No.: 14/817,241

(22) Filed: Aug. 4, 2015

(51) Int. Cl. G06F 3/041; G06F 3/044

(52) U.S. Cl. CPC G06F 3/0418; G06F 3/0412; G06F 3/044; G06F 2203/04108; G06F 2203/04111

(57) ABSTRACT

A method, computer program product, and system for generating pattern data in response to placing a primary plane of a capacitive signature label in close physical proximity with a primary plane of a capacitive touch screen to cause a measurable change in capacitance by distorting the touch screen's electrostatic field, the signal is based on a two-dimensional conductive pattern of the capacitive signature label, comparing the generated pattern data with stored pattern data, and performing an action associated with a particular stored pattern data matching the generated pattern data.

### BACKGROUND

The present invention relates generally to the field of capacitive touch screens and more particularly to an input device and method for a capacitive touch screen.

There exist today many styles of input devices for performing operations in a computer system. The operations generally correspond to moving a cursor and/or making selections on a display screen. By way of example, the input devices may include buttons or keys, mice, trackballs, touch pads, joy sticks, touch screens and the like. Each of these devices has advantages and disadvantages that are taken into account when designing or configuring a computer system.

Touch screens, in particular, are becoming increasingly popular because of their ease and versatility of operation as well as to their declining price. Touch screens allow a user to make selections and move a cursor by simply touching the display screen via a finger or stylus. For example, a user may make a selection by pointing directly to a graphical object displayed on the display screen. The graphical object may for example correspond to an on-screen button for performing specific actions in the computer system. In general, the touch screen recognizes the touch and position of the touch on the display screen and the computer system interprets the touch and thereafter performs an action based on the touch event. There are several types of touch screen technologies including resistive, capacitive, infrared and surface acoustic wave.

Computer based systems utilizing touch screens have been used in many settings including retail, commercial, industrial, office, hospitality, education, and gaming environments, etc. By way of example, popular applications include information kiosks, automated teller machines (ATM), point of sale machines (POS), industrial machines, gaming machines, arcade machines, vending machines, airline e-ticket terminals, restaurant reservation terminals, customer service stations, library terminals, learning devices, etc.

In environments utilizing POS machines, it is common practice to assign levels of authority to various individuals on the staff. For example, a sales clerk may be able to enter sales information but does not have the authority to make a refund. A supervisor is generally needed to execute a refund. The sales clerk and the supervisor may use the same POS terminal, but each of them will have a unique login code. Login codes are easily stolen or otherwise compromised. One well known solution to improve security is the use of physical keys. The owner of the physical key will know if it is stolen, whereas a stolen login code leaves no trace if stolen. Typically, physical keys are expensive and the terminals must be equipped with a locking mechanism that serve no function other than security.

Similar situations can be found in industrial settings where process conditions are tightly controlled. For example, an operator may be able to operate industrial machine but does not have authority to make changes to any of the process parameters associated with the industrial machine. In cases such as these, a supervisor is needed to make a change.

Similar situations may arise in work, libraries, and schools where computer terminals are shared by a number of different users. For example, a user may be able to use the computer terminal for general use but does not have the authority to make changes to the configuration of the computer or network to which it is attached. In cases such as these, a network administrator is needed to make changes.

### SUMMARY

Embodiments of the present invention disclose a method, computer program product, and system for generating pattern data in response to placing a primary plane of a capacitive signature label in close physical proximity with a primary plane of a capacitive touch screen to cause a measurable change in capacitance by distorting the touch screen's electrostatic field, the signal is based on a two-dimensional conductive pattern of the capacitive signature label, comparing the generated pattern data with stored pattern data, and performing an action associated with a particular stored pattern data matching the generated pattern data.

According to another embodiment of the present invention, a capacitive signature label is provided. The capacitive signature label may include a two-dimensional conductive pattern arranged on a substantially flat surface.

### BRIEF DESCRIPTION OF THE DRAWINGS

FIG. 1 is a functional block diagram illustrating a system for pattern recognition of a capacitive signature label in a networked computer environment, in accordance with an exemplary embodiment.

FIG. 2 is a functional block diagram illustrating a simplified diagram of a pattern recognition system, in accordance with an exemplary embodiment.

FIG. 3 is a flowchart depicting operational steps of a capacitive signature label recognition method within the pattern recognition system of FIG. 2, in accordance with an exemplary embodiment.

FIG. 4 is a flowchart depicting operational steps of a pattern recognition method within the pattern recognition system of FIG. 2, in accordance with an exemplary embodiment.

FIG. 5 is a flowchart depicting operational steps of a pattern recognition method within the pattern recognition system of FIG. 2, in accordance with an exemplary embodiment.

FIG. 6 is a flowchart depicting operational steps of a capacitive signature label update method within the pattern recognition system of FIG. 2, in accordance with an exemplary embodiment.

FIGS. 7a and 7b depict examples of the capacitive signature label, in accordance with an exemplary embodiment.

FIG. 8 is a functional block diagram of component of a computing device executing the pattern recognition program, in accordance with an exemplary embodiment.

### DETAILED DESCRIPTION

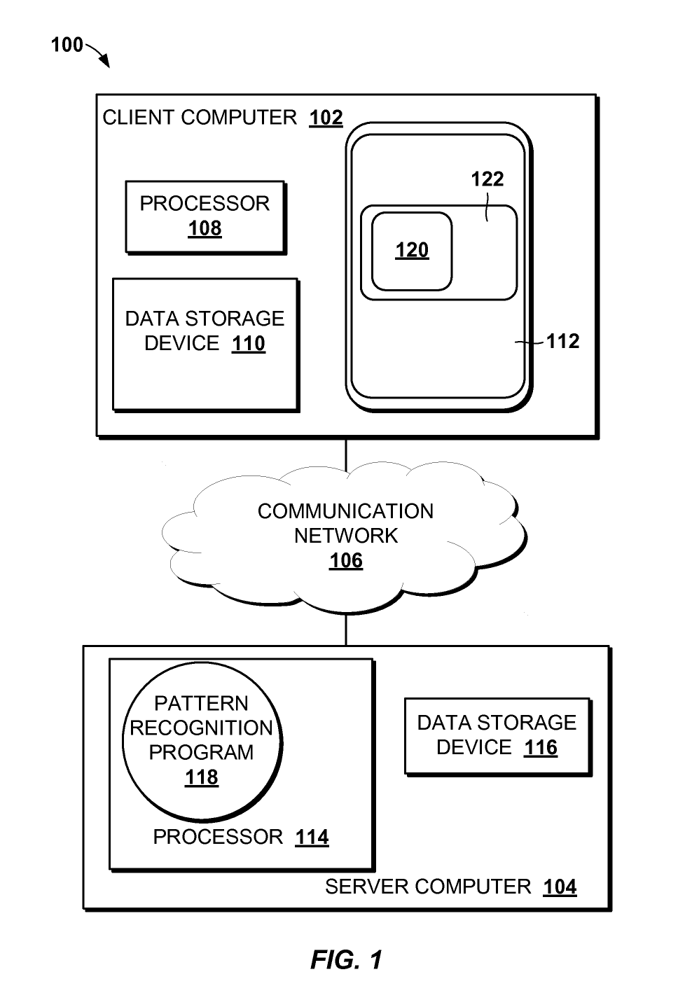

Embodiments of the invention are discussed below with reference to FIGS. 1-9. However, those skilled in the art will readily appreciate that the detailed description given herein with respect to these figures is for explanatory purposes as the invention extends beyond these limited embodiments.

Referring now to FIG. 1, a functional block diagram illustrating a system 100 for inputting data using a capacitive touch screen in a networked computer environment, in accordance with an embodiment of the present invention is shown. The system 100 may include a client computer 102 and a server computer 104. The client computer 102 may communicate with the server computer 104 via a communications network 106 (hereinafter “network”). The client computer 102 may include a processor 108, a data storage device 110, a touch screen 112, and is enabled to interface with a user and communicate with the server computer 104. The server computer 104 may also include a processor 114 and a data storage device 116 that is enabled to run a pattern recognition program 118. In an embodiment, the client computer 102 may operate as an input device including a user interface while the pattern recognition program 118 may run primarily on the server computer 104. In an alternative embodiment, the pattern recognition program 118 may run primarily on the client computer 102 while the server computer 104 may be used for processing a storage of data used by the pattern recognition program 118.

It should be noted, however, that processing for the pattern recognition program 118 may, in some instances be shared amongst the client computer 102 and the server computer 104 in any ratio. In another embodiment, the pattern recognition program 118 may operate on more than one server computer 104, client computer 102, or some combination of server computers 104 and client computers 102, for example, a plurality of client computers 102 communicating across the network 106 with a single server computer 104.

The network 106 may include wired connections, wireless connections, fiber optic connections, or some combination thereof. In general, the network 106 can be any combination of connections and protocols that will support communications between the client computer 102 and the server computer 104. The network 106 may include various types of networks, such as, for example, a local area network (LAN), a wide area network (WAN) such as the Internet, a telecommunication network, a wireless network, a public switched network and/or a satellite network.

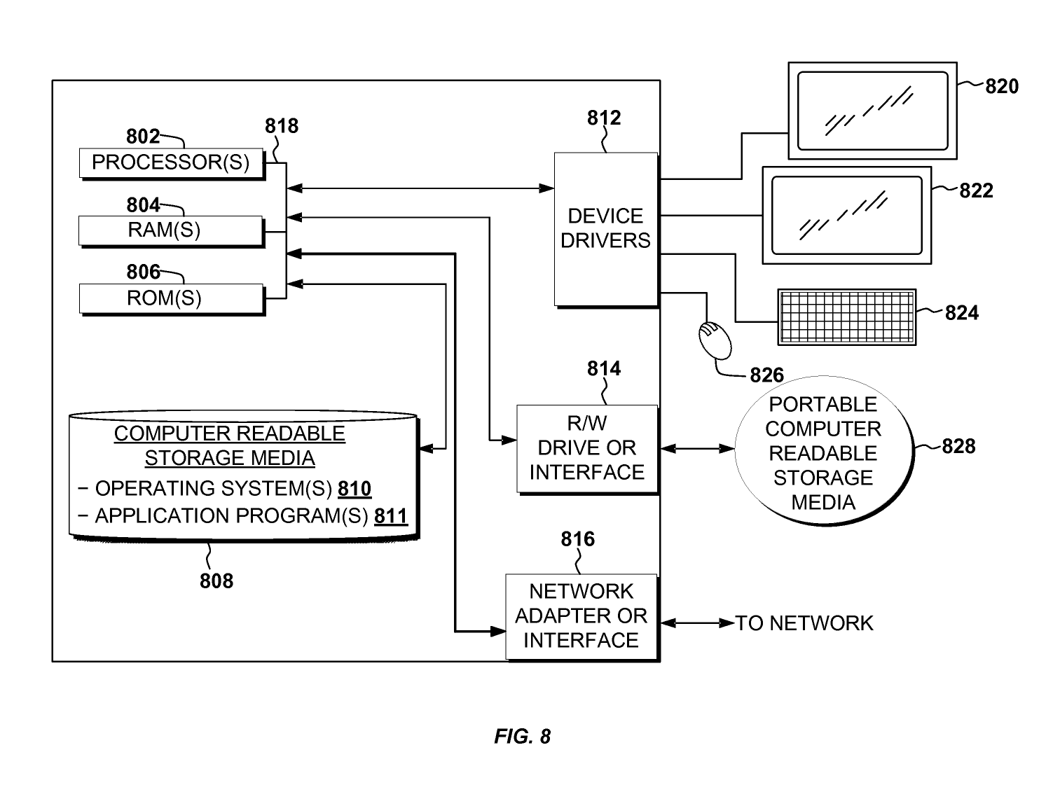

In various embodiments, the client computer 102 and/or the server computer 104 may be, for example, a laptop computer, tablet computer, netbook computer, personal computer (PC), a desktop computer, a personal digital assistant (PDA), a smart phone, a mobile device, or any programmable electronic device capable of communicating with the server computer 104 via the network 106. As described below with reference to FIG. 8, the client computer 102 and the server computer 104 may each include internal and external components.

In an embodiment, the system 100 may include any number of client computers 102 and/or server computers 104; however only one of each is shown for illustrative purposes only. It may be appreciated that FIG. 1 provides only an illustration of one implementation and does not imply any limitations with regard to the environments in which different embodiments may be implemented. Many modifications to the depicted environments may be made based on design and implementation requirements.

The system 100 may be generally configured to perform actions when a capacitive signature label 120 is presented to, or brought in contact with, a touch sensing device, such as the touch screen 112. The capacitive signature label 120 preferably includes an array of conductive elements, arranged in a pattern that can be acquired by the touch screen 112 when the capacitive signature label 120 is placed on the touch screen 112. The capacitive signature label 120 may be affixed to, or integrated within, a device 122. In an embodiment, the touch screen 112 generates label data associated with the label's pattern and forwards the label data to the client computer 102. When the client computer 102 recognizes the label data, the client computer 102 initiates an action associated with the label data. In another embodiment, the touch screen 112 generates label data associated with the label's pattern and forwards the label data to the server computer 104 via the client computer 102 and the network 106.

The actions, may for example, include logging onto a computer or a computer network, permitting authorized individuals access to restricted areas of the computer or computer network, loading a user profile associated with a user's preferred arrangement of the computer desktop, permitting access to web content, launching a particular program, opening a file or document, viewing a menu, making a selection, executing instructions, encrypting or decoding a message, operating an input/output device operatively connected to the computer, transmitting data between the capacitive signature label 120 and the touch screen 112, or some combination thereof.

The pattern may substantially vary from one capacitive signature label to another. In general, the pattern of the capacitive signature label 120 is substantially two dimensional such that it can be brought into contact with the substantially planar surface of the touch screen 112 in its entirety. The pattern need not be raised, and should not be recessed for purpose of detection by the touch screen 112. The capacitive signature label 120 may be a stand-alone label attachable to any object or device, or it may be formed directly on or in an object or an integrated component of a device. In an embodiment the pattern of the capacitive signature label 120 may include a two dimensional array of conductive elements. The touch screen 112 may also be widely varied, for example, it may be based on sensing technologies including but not limited to capacitive and the like.

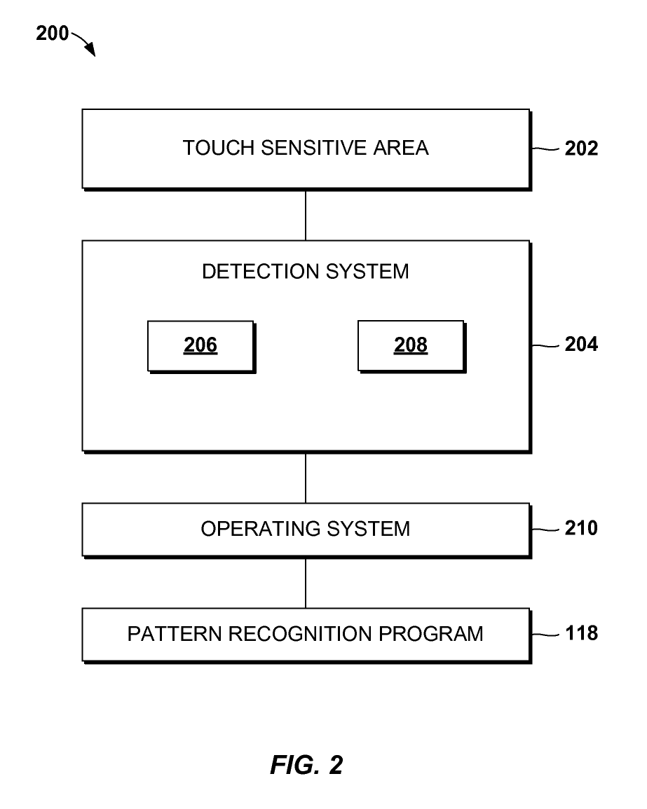

The pattern recognition program 118 and associated methods are described and explained in further detail below with reference to FIGS. 2-7.

Referring now to FIG. 2, and with continued reference to FIG. 1, a simplified diagram of a pattern recognition system 200 is shown in accordance with an embodiment of the present invention. The pattern recognition system 200 may be configured to perform pattern recognition, particularly to recognize the pattern of the capacitive signature label 120 (FIG. 1). The pattern recognition system 200 may for example be used in conjunction with the computer hardware shown in FIG. 1. The pattern recognition system 200 includes a touch sensitive area 202 for receiving the capacitive signature label, such as, for example, the touch screen 112 of FIG. 1. The pattern recognition system 200 further includes a detection system 204 capable of detecting the pattern of the capacitive signature label 120, of FIG. 1. The detection system 204 may for example include a sensing device 206 configured to register touches positioned over the touch sensitive area, and control circuitry 208 that monitors the touch events and translates the touch events into other events in conjunction with its programming.

The sensing device 206 may for example correspond to a touch screen, such as, for example, a capacitive touch screen. The control circuitry 208, on the other hand, typically includes a controller and a processor (not shown). The controller is configured to convert the touches into touch events. The processor is responsible for interpreting the touch events and transmitting the results to other devices. In one particular operation, the controller monitors the signals from the sensing device 206 and passes signals representative of the touch signals to the processor.

The programming may for example include an operating system 210 and the pattern recognition program 118, of FIG. 1. Operating systems are generally well known and will not be described in greater detail. By way of example, the operating system may correspond to OS/2, DOS, Unix, Linux and the like. The pattern recognition program 118, which may be part of the operating system or a separate piece of software, generally includes a set of instructions that recognizes capacitive signature label touch events and informs a system of the touch events and/or what action to take in response to the touch events.

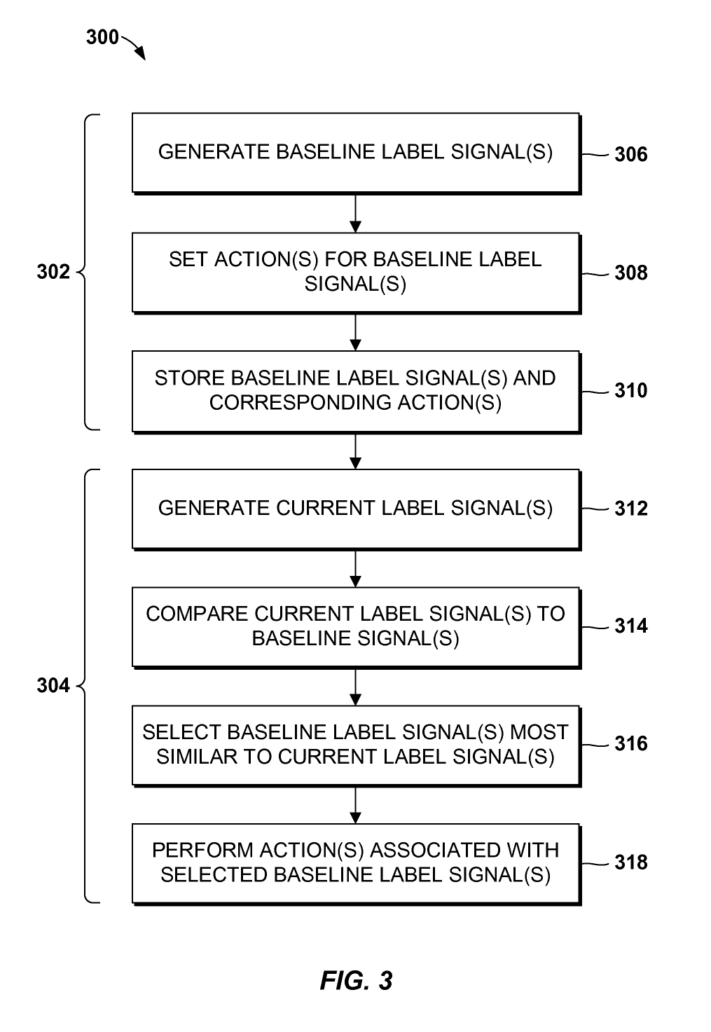

Referring now to FIG. 3, a capacitive signature label recognition method 300 is shown in accordance with an embodiment of the present invention. The method 300 is generally performed in multiple steps including a calibration step 302 and an in-use step 304. The calibration step 302 is performed before the in-use step 304. The calibration step 302 is generally performed once, while the in-use step 304 is performed as needed during computer use. The calibration step 302 generally begins at block 306 where baseline label signals are generated for each capacitive signature label. This may for example be accomplished by placing one or more capacitive signature labels on a touch sensing device such as a touch screen. The label signals are based on the pattern of the capacitive signature label. Following block 306, the process flow proceeds to block 308 where the actions for one or more baseline label signals are set. For example, a first action may be associated or paired with a first baseline label signal and a second action may be associated to a second baseline label signal (and so on). In addition, for example, a third action may be associated or paired to both the first and second baseline signals. Following block 308, the process flow proceeds to block 310 where the baseline label signal and associated action(s) are stored, such as in a capacitive signature label database. The label database may for example be associated with the pattern recognition program 118 stored in memory.

The in-use step 304 generally begins at block 312 where a current label signal is generated. This may, for example, be accomplished by placing one or more capacitive signature labels on a touch sensing device such as a touch screen. Following block 312, the process flow proceeds to block 314 where the current label signal is compared to the baseline label signals stored in the label database. Following block 314, the process flow proceeds to block 316 where the baseline label signal most similar to the current label signal is selected. By way of example, the difference between the baseline and current signal may be determined or measured. If this difference is minimal or within a desired threshold then it can be assumed that a match has been made. If there is no signal similar to the current signal then the user may be prompted to repeat the in-use step 304. Following block 316, the process flow proceeds to block 318 where the actions associated with the selected baseline label signals are performed.

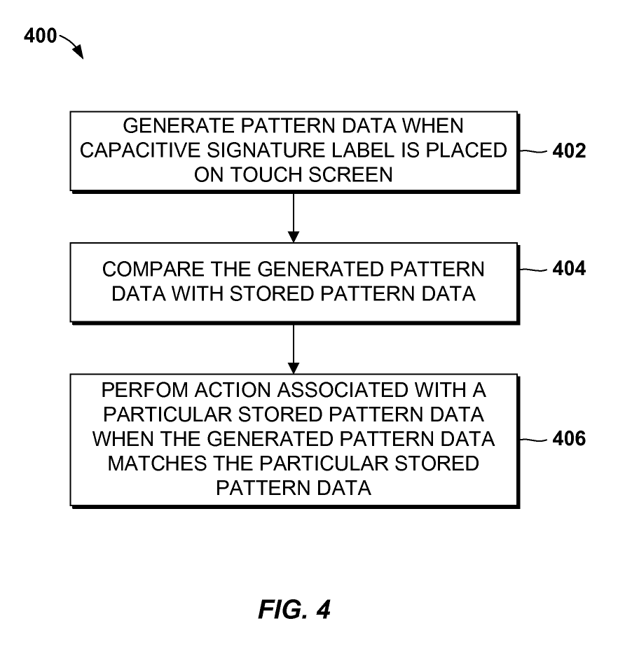

Referring now to FIG. 4, a pattern recognition method 400 is shown in accordance with an embodiment of the present invention. The pattern recognition method 400 may, for example, be used in the system 100 shown in FIG. 1. The pattern recognition method 400 may generally begin when pattern data is generated when the capacitive signature label 120 placed on the touch sensitive surface of a touch screen (step 402). The pattern data may generally include pattern information associated with the capacitive signature label 120 (FIG. 1). The process flow may proceed with comparing the generated pattern data with stored pattern data (step 404). The stored pattern data may be contained in a library or database and typically includes pattern data corresponding to one or more capacitive signature labels. The stored pattern data is generally predetermined. By way of example, a calibration sequence may be used to update the stored pattern data. Finally, an action associated with a particular stored pattern data can be performed when the generated pattern data matches the particular stored pattern data (step 406). The action associated therewith can be predetermined and the predetermination may be part of a calibration sequence.

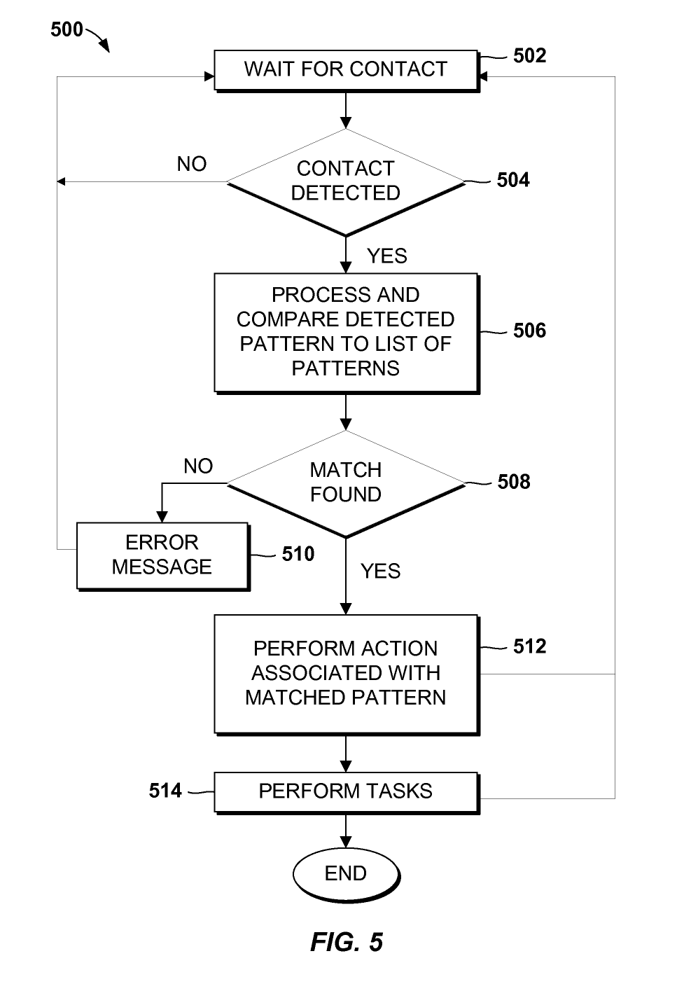

Referring now FIG. 5 a pattern recognition method 500 is shown in accordance with an embodiment of the present invention. By way of example, the pattern recognition method 500 may be performed using the pattern recognition system 200 shown in FIG. 2. The pattern recognition method 500 generally begins at block 502 where the touch screen is in standby. Standby generally implies that the touch screen is in a state of readiness waiting for something to happen, for example, waiting for a user to place a capacitive signature label on the touch screen. Following block 502, the process flow proceeds to block 504 where a determination is made as to whether contact has been made on the touch screen. For example, a primary plan of the capacitive signature label is placed in close physical proximity to a primary plan of the touch screen. If it is determined that there is no contact, then the process flow proceeds back to block 502 thus the touch screen remains in standby. If it is determined that there is contact, then the process flow proceeds to block 506 where the pattern of the capacitive signature label area is compared to a list of patterns. If a match is not found, at 508, the process flow proceeds to block 510 where an error message such as “no match found” or “invalid label” or “label not recognized please try again” is presented to the user to inform the user that the label was not recognized. Thereafter, the process flow proceeds back to block 502. Alternatively, the process flow may skip block 510 altogether, for example, present no message to the user.

If a match is found, at 508, the process flow proceeds to block 512 where an action associated with the matched pattern is performed. The actions may be widely varied. The actions may include, for example, logging onto the computer or a computer network, permitting authorized individuals access to restricted areas of the computer or computer network, loading a user profile associated with a user's preferred arrangement of the computer desktop, permitting access to web content, launching a particular program or application, opening a file or document, viewing a menu making a selection, executing instructions, encrypting or decoding a message, operating an input/output device operatively connected to the computer, transferring data between the capacitive signature label 120 and the touch screen 112, both of FIG. 1, and/or the like.

In one embodiment, the action includes opening restricted areas within a computer system. After the restricted areas are opened, the process flow proceeds to block 514 where a user is allowed to perform authorized tasks. This particular implementation may be useful in retail environments where store clerks have authorization for performing low level transactions such as entering an order, but may not have authorization for performing high level transactions such as issuing a refund. In cases such as these, a store manager wielding a high level signature label may be required. The store manager simply places the high level capacitive signature label on the touch screen in order to authorize the high level transaction that may be required. As should be appreciated, there may be different labels for different restricted areas and thus different levels of authorization. In order to log out of this level, the store manager may need to place the high level label on the touch screen a second time. Alternatively, there may be an icon on the touch screen that initiates a log out when selected. Alternatively, the log out may occur after a predetermined amount of time, e.g., times out. In yet another embodiment, the high level access may only be available so long as the capacitive signature label in is contact with the touch screen and removal of the label from the touch screen may initiate a ‘log out’ sequence.

Along a similar vein, several capacitive signature labels may be issued with each label representing a different action. For example, a plant manager may have labels for turning an air conditioner unit on and off, turning exterior or interior lights on and off, operating a waste water treatment system, activating a material feed system, and the like.

In another embodiment, the action initiated by placement of a capacitive signature label on a touch screen may include configuring a computer system to a particular user. The user therefore does not have to fiddle with a lot of different controls. For example, once a match is found, the computer system configures itself in accordance with the user's previously programmed settings, including but not limited to sound volume, mouse speed, screen brightness, menus, preferences, access privileges, preferred network connection (telephone, modem, WiFi) and the like. This is particularly advantageous in environments where the computer system is shared by multiple users, such as in education environments. Each user could have their own personal label. The user simply has to present his/her label to the touch screen in order to place the computer system in his/her preferred configuration. When the computer system has been properly configured, the process flow proceeds to block 514 where the user is allowed to perform tasks in the computer system. In order to log out of this level, the user may need to place the personal label on the touch screen a second time. Alternatively, there may be an icon on the touch screen that initiates a log out when selected. Alternatively, the log out may occur after a predetermined amount of time, for example, times out.

In another embodiment, multiple labels can be placed on a single touch screen to distinguish users in a multi-user environment. For example, multiple students using a touch table computer system in a classroom can be identified by their personal capacitive signature label. In such cases each student's label identifies them and provides their location/position around the touch table. In addition, each student's label may initiate one or more actions when presented or placed on the touch table. Exemplary actions in the present embodiment include, for example, logging onto the system, loading a user profile, and the like.

In some situations, it may be desirable to require multiple labels in order to perform any one action. This may, for example, function similar to a combination lock. The multiple labels may further be required to be placed in a particular orientation relative to one another, and/or in a particular order. The multiple labels may preferably be unique from one another, but may have some similarities.

In one embodiment, two or more labels are detected on the surface of the touch screen at the same time and thereafter the combination is compared to a list of patterns including various combinations of patterns in blocks 504 and 506. Like above, if there is a match the process flow proceeds to block 512 where an action associated with the matched pattern is performed. This particular implementation may be useful in situations where checks and balances are needed for the action to be performed. For example, in order to launch a rocket, two distinct labels owned by two different individuals may need to be presented to the touch screen in order to allow a rocket launching sequence to begin.

In another embodiment, one or more labels are detected on the surface of the touch screen at the different times and thereafter the label sequence is compared to a list of label sequences as in blocks 504 and 506. That is, each time a label is placed on the touch screen the process flow performs steps 504 and 506 until the desired sequence is complete. If each label in the label sequence matches its appropriate pattern in the sequence, the process flow can continue to block 512 where an action associated with the label sequence is performed.

In another embodiment, the action is configured to launch a program that outputs personal identification or credit information associated with the label. The user owning the label simply places the label on the touch screen so as to launch a program that brings up personal identification, credit information or the like. This may be advantageous in retail or financial environments such as stores or banks.

In another embodiment, the action is configured to open a particular program or web site. This may be down in conjunction with a promotional label. If the owner of the label has the winning label the web site may indicate that the user has won something. The promotional label may be bundled with other products, physically attached to a consumer product, or given out as for example at a trade show. In addition, there may be a promotional kiosk for receiving the promotional labels. That way, the owner can readily determine if they won anything.

In another embodiment, the action includes decoding or encrypting a message. That is, the label could be used to encode or encrypt a message. The recipient of the message would also need a label in order to decode or unencrypt the message.

It should be noted that block 506 may include several sub steps including for example determining whether the contact is from a finger, stylus, or capacitive signature label. For example, block 506 may include comparing all patterns in order to determine if the touch is from a finger, stylus or label. As should be appreciated, the pattern of fingers (oval) and stylus (point) relatively different from a pattern of a capacitive signature label and may be easily filtered out. If a finger or stylus is detected, the method continues along a conventional touch screen operational path, for example, tracking. If a capacitive signature label is detected, the process flow proceeds to block 508.

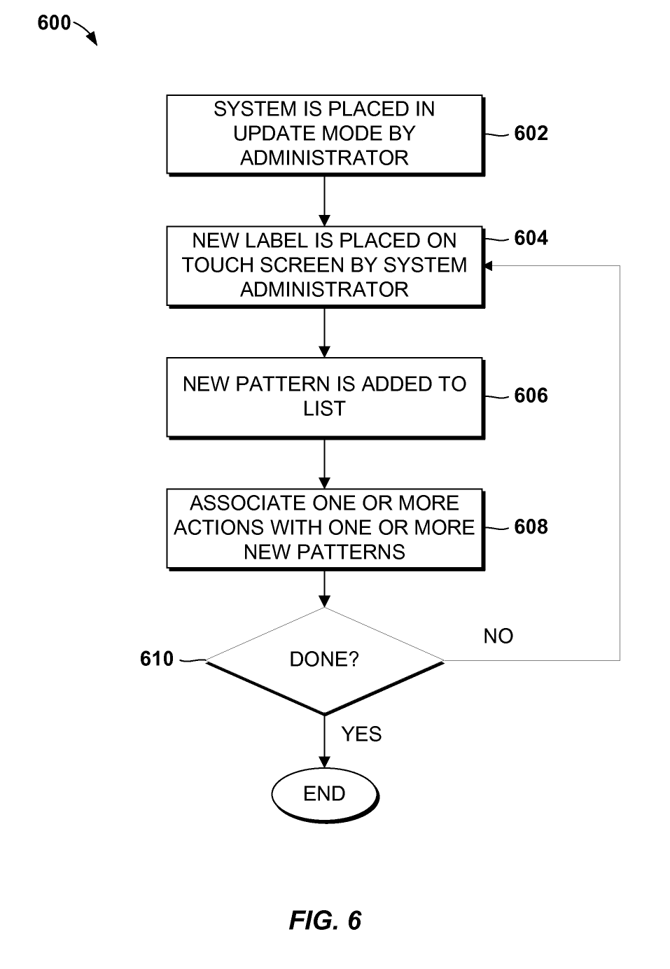

Referring now to FIG. 6 a capacitive signature label update method 600 (hereinafter “update method”) is shown in accordance with an embodiment of the present invention. The update method 600 is generally configured for adding labels to a database or list. This update method 600 may for example be performed before the pattern recognition method 500 of FIG. 5 so that a list is available in block 506. The update method 600 may also be performed at various times through a computer system's life in order to add new labels that were not part of an original batch.

The update method 600 generally begins at block 602 where a computer system is placed in update mode by a system administrator. This may for example be accomplished using the method described above. For example, using a system administer label, a system administrator may be able to access a label update menu. Following block 602, the process flow proceeds to block 604 where a new label is placed on the touch screen by the system administrator. The new label may for example correspond to a new user such as a new store manager. Following block 604, the process flow proceeds to block 606, where a new label pattern is added to the list. For example, the system administrator places the new pattern in an existing database containing patterns for various labels. Following block 606, the process flow proceeds to block 608 where one or more actions are assigned to the new label and as such the new pattern. For example, the new label may be assigned to allow the user to gain access to restricted areas inside the computer system. The new label may also be assigned to configure the computer system in a particular manner. Following block 608, the process flow proceeds to block 610 where a decision is made with regard to adding another label or ending the process flow. If another label is to be added, then the process flow proceeds to back to block 604.

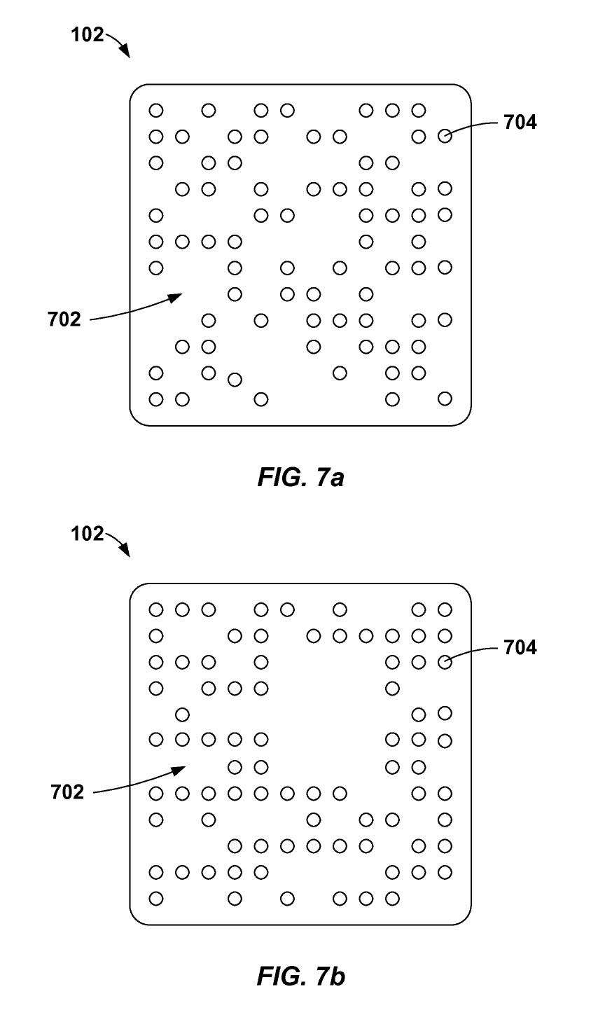

FIGS. 7a and 7b shows two examples of the capacitive signature label 120 (FIG. 1) that may be used in the various embodiments of the present invention described above. The capacitive signature label 120 includes a pattern 702. The pattern 702 may be associated with one or more preprogrammed actions on a computer system, such as the client computer 102 or the server computer 104, both of FIG. 1. In other words, the pattern 702, and as such the capacitive signature label 120, may be used to initiate a particular action on the computer system, as described above. The action may for example configure the computer system to a particular user such as a person (e.g., Bob Smith) or authority (e.g., manager), open restricted areas of the computer system or initiate a control function (e.g., turn on lights).

The capacitive signature label 120 itself may be any shape and size so long as sufficient contact can be established between the pattern 702 and the touch screen 112. In general, the capacitive signature label 120 may be a simple shape such as, but not limited to, a square or rectangle. The complexity of the pattern 702 is determined by the resolution of the capacitive touch screen, that is the resolution of the capacitive detection system (204) and not the image resolution of the touch screen 112. Complex high resolution patterns (702) could allow for a very high level of discrimination between labels, similar to that of a QR code. For example, high levels of discrimination may be achieved between access levels to a computer system or between personal identities.

The pattern 702 of the capacitive signature label 120 may include a substantially flat two-dimensional array of conductive elements 704. Generally, all of the conductive elements 704 would have a similar shape and size; however, it is not required. In another embodiment, the conductive elements 704 may be different shapes, different sizes, or both. In some embodiments, the pattern 702 includes a distinguishing feature that which may be used to detect or identify an orientation of the capacitive signature label 120. For example, a single conductive element 704 may be present in only three of the four corners, as shown in the figures. In another embodiment, each corner of the capacitive signature label 120 may be occupied by a conductive element 704; however, one conductive element 704 may have a different shape, size, or both from the other three conductive elements 704.

The capacitive signature label 120 may operate as a passive label, an active label, or both. The passive capacitive signature label 120 may be fixed to the base of the device 122 (FIG. 1), and would enable the computer system to recognize the devices type and identity. In addition, the passive label may also be able to communicate the device's position and orientation when moved around the touch screen 112, such as, for example, a touch table in an education setting as described above. In an embodiment, the passive label is used to identify a non-powered device in direct contact with the touch screen 112.

The active capacitive signature label, unlike the passive label, would have an electrical connection to a device. In such examples, one or more conductors may be used to transmit information to the capacitive touch screen by charge variation. More specifically, electronics are used to vary the charge on different conductors in the pattern 704. This variation could be detected by the capacitive touch screen 112, and thus information could be passed to the touch screen 112, from the device, for example, a button press or a binary access code.

In an embodiment, some conductive elements are active and used to transmit information while other conductive elements remain passive and are used purely for identification and orientation. In all cases the array of conductive elements communicates information to the touch screen, whether or not passive or active. In terms of a passive label, the conductive elements generally communicate a fix amount of static information, while the conductive elements of the active label is capable of communicating an unlimited amount of dynamic information. In other words, the information communicated by a passive label cannot generally be changed, while the information communicated by an active label can be changed on the fly, real time. The active label could be used as an input port or connection for passing information to the touch screen and as such the computer (102).

Referring now to FIG. 8, a block diagram of components of a computing device, such as the client computer 102 or the server computer 104, of the system 100 of FIG. 1, in accordance with an embodiment of the present invention is shown. It should be appreciated that FIG. 8 provides only an illustration of one implementation and does not imply any limitations with regard to the environments in which different embodiments may be implemented. Many modifications to the depicted environment may be made.

The computing device may include one or more processors 802 (hereinafter “processor”), one or more computer-readable RAMs 804, one or more computer-readable ROMs 806, one or more computer readable storage media 808, device drivers 812, a read/write drive or interface 814, a network adapter or interface 816, all interconnected over a communications fabric 818. The communications fabric 818 may be implemented with any architecture designed for passing data and/or control information between processors (such as microprocessors, communications and network processors, etc.), system memory, peripheral devices, and any other hardware components within a system.

One or more operating systems 810, and one or more application programs 811, for example, the pattern recognition program 118, are stored on the one or more of the computer readable storage media 808 for execution by one or more of the processor 802 via one or more of the respective RAMs 804 (which typically include cache memory). In the illustrated embodiment, each of the computer readable storage media 808 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

The computing device may also include the R/W drive or interface 814 to read from and write to one or more portable computer readable storage media 828. Application programs 811 on the computing device may be stored on one or more of the portable computer readable storage media 828, read via the respective R/W drive or interface 814 and loaded into the respective computer readable storage media 808.

The computing device may also include the network adapter or interface 816, such as a TCP/IP adapter card or wireless communication adapter (such as a 4G wireless communication adapter using OFDMA technology). Application programs 811 on the computing device may be downloaded to the computing device from an external computer or external storage device via a network (for example, the Internet, a local area network or other wide area network or wireless network) and network adapter or interface 816. From the network adapter or interface 816, the programs may be loaded onto computer readable storage media 808. The network may comprise copper wires, optical fibers, wireless transmission, routers, firewalls, switches, gateway computers and/or edge servers.

The computing device may also include a display screen 820, a touch screen 822, a keyboard or keypad 824, and a computer mouse or touchpad 826. The device drivers 812 interface to the display screen 820 for imaging, to the keyboard or keypad 824, to the computer mouse or touchpad 826, and/or to the display screen 820 for pressure sensing of alphanumeric character entry and user selections. The device drivers 812, R/W drive or interface 814 and network adapter or interface 816 may include hardware and software (stored on computer readable storage media 808 and/or ROM 806). In some embodiments, the touch screen 822 may be the touch screen 112 described in detail above.

With continued reference to FIGS. 2 and 8, both the display screen 820 the touch screen 822 are operatively coupled to the processor 802. The display screen 820 is configured to display a graphical user interface (GUI) including perhaps a pointer or cursor as well as other information to the user. By way of example, the display screen 820 may be a monochrome display, color graphics adapter (CGA) display, enhanced graphics adapter (EGA) display, variable-graphics-array (VGA) display, super VGA display, liquid crystal display (e.g., active matrix, passive matrix and the like), cathode ray tube (CRT), plasma displays and the like.

In most cases, the touch screen 822 is a transparent panel that is positioned in front of the display screen 820. The touch screen 822 may be integrated with the display screen 820 or it may be a separate component. The touch screen 822 is configured to receive input from a user's touch and to send this information to the processor 802. In most cases, the touch screen 822 recognizes touches and the position of touches on its surface. The touch screen 822 reports the touches to the processor 802 and the processor 802 interprets the touches in accordance with its programming. For example, the processor 802 may initiate a task in accordance with a particular touch.

The touch screen 822 generally includes a sensing device 206 configured to register touches positioned over the touch screen 822. The sensing device may include any capacitive sensing technology known to a person of ordinary skill in the art. Although not shown, the touch screen 822 may also include a microcontroller that acquires the data from the sensing device 206 and that supplies the acquired data to the processor 802. In one embodiment, the microcontroller is configured to send raw data to the processor 802 so that the processor 802 processes the raw data. For example, the processor 802 receives data from the microcontroller and then determines how the data is to be used within the computing device. In another embodiment, the microcontroller is configured to process the raw data itself. That is, the microcontroller registers touch events and turns them into other form factors before sending or reporting them to the processor 802. By way of example, the microcontroller may convert the raw data into processed data that the processor 802 can understand. This processed data may have similar or different units as the raw data.

The microcontroller itself may include a storage element for storing a touch screen program, which is a capable of controlling different aspects of the touch screen 822. For example, the touch screen program may contain what type of value to output based on the touch events (e.g., coordinates). In fact, the microcontroller in conjunction with the touch screen program may follow a predetermined communication protocol. As is generally well known, communication protocols are a set of rules and procedures for exchanging data between two devices. Communication protocols typically transmit information in data blocks or packets that contain the data to be transmitted, the data required to direct the packet to its destination, and the data that corrects errors that occur along the way.

In one implementation, the microcontroller corresponds to an application specific integrated circuit (ASIC), which works with firmware to monitor the signals from the sensing device 206 and to process the monitored signals and to report this information to the processor 802.

The signals generated by the touch events are generally used to perform various functions including but not limited to moving a cursor or pointer (e.g., tracking) or for making selections. For example, if a user desires to actuate a virtual button on the display screen 820, the user simply places their finger or stylus over the virtual button. The microcontroller outputs the position data representative of the position of the finger or stylus on the touch screen 822, and the processor 802 determines if the position data corresponds to the position of the virtual button. If the position of the finger corresponds to the location of the virtual button on the display screen 820, then the processor 802 initiates an action associated with the virtual button.

In accordance with one embodiment of the present invention, the signals generated at the touch events of the touch screen 822 are also used to determine the pattern of the capacitive signature label 120, as described in detail above.

Although not a requirement, the pattern recognition programming described above may be very high in hierarchy of interrupts in the operating system. That is, determining whether the touch event is a capacitive signature label and thereafter the pattern of the label would take precedent over other types of processing actions. For example, if a virtual button is displayed on the screen, the user is allowed to place the label over the virtual button and the computer system would read the pattern of the label and perform an action associated therewith rather than activating the on-screen virtual button.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Based on the foregoing, a computer system, method, and computer program product have been disclosed. However, numerous modifications and substitutions can be made without deviating from the scope of the present invention. Therefore, the present invention has been disclosed by way of example and not limitation.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Based on the foregoing, a computer system, method, and computer program product have been disclosed. However, numerous modifications and substitutions can be made without deviating from the scope of the present invention. Therefore, the present invention has been disclosed by way of example and not limitation.

What is claimed is:

1. A method comprising:
generating pattern data in response to placing a primary plane of a capacitive signature label in close physical proximity with a primary plane of a capacitive touch screen to cause a measurable change in capacitance by distorting the touch screen's electrostatic field, the generated pattern data is based on a two-dimensional conductive pattern of the capacitive signature label;
comparing the generated pattern data with stored pattern data; and
performing an action associated with a particular stored pattern data matching the generated pattern data.

2. The method of claim 1, further comprising:
transmitting information between the touch screen and a device by toggling electrical signals for individual conductors of a portion of the conductive pattern.

3. The method of claim 1, further comprising:
detecting an orientation, a location, or both of the capacitive signature label relative to the touch screen.

4. The method of claim 1, further comprising:
detecting contact of the capacitive signature label by the touch screen.

5. The method of claim 1, further comprising:
storing the generated pattern data; and
associating the action with the generated pattern data.

6. The method of claim 1, wherein performing the action associated with the particular stored pattern data comprises:
logging onto a computer or a computer network, permitting authorized individuals access to restricted areas of the computer or the computer network, loading a user profile associated with a user's preferred arrangement of a computer desktop, permitting access to web content, launching a particular program, opening a file or document, viewing a menu, making a selection, executing instructions, encrypting or decoding a message, operating an input/output device operatively connected to the computer, transmitting data between the capacitive signature label and the touch screen, or some combination thereof.

7. A computer program product comprising:
one or more computer-readable storage media and program instructions stored on the one or more computer-readable storage media, the program instructions comprising:
program instructions to generate pattern data in response to placing a primary plane of a capacitive signature label in close physical proximity with a primary plane of a capacitive touch screen to cause a measurable change in capacitance by distorting the touch screen's electrostatic field, the generated pattern data is based on a two-dimensional conductive pattern of the capacitive signature label;
program instructions to compare the generated pattern data with stored pattern data; and
program instructions to perform an action associated with a particular stored pattern data matching the generated pattern data.

8. The computer program product of claim 7, further comprising:
program instructions to transmit information between the touch screen and a device by toggling electrical signals for individual conductors of a portion of the conductive pattern.

9. The computer program product of claim 7, further comprising:
program instructions to detect an orientation, a location, or both of the capacitive signature label relative to the touch screen.

10. The computer program product of claim 7, further comprising:
program instructions to detect contact of the capacitive signature label by the touch screen.

11. The computer program product of claim 7, further comprising:
program instructions to store the generated pattern data; and
program instructions to associate the action with the generated pattern data.

12. The computer program product of claim 7, wherein performing the action associated with the particular stored pattern data comprises:
program instructions to log onto a computer or a computer network, permit authorized individuals access to restricted areas of the computer or the computer network, load a user profile associated with a user's preferred arrangement of a computer desktop, permit access to web content, launch a particular program, open a file or document, view a menu, make a selection, execute instructions, encrypt or decode a message, operate an input/output device operatively connected to the computer, transmit data between the capacitive signature label and the touch screen, or some combination thereof.

13. A capacitive signature label comprising:
a two-dimensional conductive pattern arranged on a substantially flat surface.

14. The capacitive signature label of claim 13, wherein the conductive pattern is a passive component of a device without any physical or electrical functionality.

15. The capacitive signature label of claim 13, wherein the conductive pattern is an active component of a device, and at least a portion of the conductive pattern is electrically coupled to a computer of the device such that electrical signals of individual conductors are toggled to transmit information between the device and a touch screen.

16. The capacitive signature label of claim 13, wherein the conductive pattern comprises a substantially symmetrical array of conductive elements.

17. The capacitive signature label of claim 13, wherein the conductive pattern comprises a substantially random array of conductive elements.

18. The capacitive signature label of claim 13, wherein the conductive pattern comprises at least one metallic element.

19. The capacitive signature label of claim 13, wherein the conductive pattern comprises a conductive ink printed directly on a non-conductive surface.

20. The capacitive signature label of claim 13, wherein the capacitive signature label comprises an adhesive backing opposite the conductive pattern.
